(19) United States
(12) Patent Application Publication
(10) Pub. No.: US 2013/0155646 A1
(43) Pub. Date: Jun. 20, 2013

(54) LED TUBULAR LAMP

(71) Applicant: Liqiang Zhang, Yuyao City (CN)

(72) Inventor: Liqiang Zhang, Yuyao City (CN)

(73) Assignee: NINGBO BAISHI ELECTRIC CO., LTD., Zhejiang Province (CN)

(21) Appl. No.: 13/500,669

(22) PCT Filed: Dec. 21, 2011
(86) PCT No.: PCT/CN11/84224

§ 371 Date: May 2, 2012

(30) Foreign Application Priority Data
Dec. 15, 2011 (CN) 201110420820.2

(51) Int. Cl. F21V 7/22; F21V 29/00; F21V 9/16; F21V 29/02

(52) U.S. Cl. 362/84; 362/217.05; 362/218

(57) ABSTRACT

A LED tubular lamp has a luminous tube, a center column, a plurality of LED chips, fixtures, connective plates and lamp heads; a plurality of grooves are provided on the center column, materials having high reflectivity are provided on the grooves, the plurality of LED chips are arranged on the grooves so as to form a light source with 360-degree light irradiation, the center column is provided in the luminous tube and fixedly connected to lamp heads via the fixtures and the connective plates. The LED tubular lamp can emit light at an angle of 360 degrees, thereby increasing the range of the irradiation of the luminous tube, making light more even and the problem of glaring being solved.

### TECHNICAL FIELD

The present invention relates to LED illumination technical field, more particularly, to a LED tubular lamp.

### BACKGROUND

A current LED tubular lamp generally has a light irradiation angle of 180 degrees, and the light intensity on both ends of luminous surface is much less than its middle portion. Thus the current LED tubular has serious glaringness and differs from the feature of 360-degree light irradiation of traditional tubular lamp.

### SUMMARY

The technical problem to be address of the present invention is to provide a LED tubular lamp so as to overcome the disadvantages of the poor light irradiation range and the uneven distribution of light irradiation.

In order to achieve above object, the technical solution according to the present invention provides a LED tubular lamp, comprising a luminous tube, a center column, a plurality of LED chips, fixtures, connective plates and lamp heads; a plurality of grooves are provided on the center column, materials having high reflectivity are provided on the grooves, the plurality of LED chips are arranged on the grooves so as to form a light source with 360-degree light irradiation, the center column is provided in the luminous tube and fixedly connected to lamp heads via the fixtures and the connective plates.

Further, fasteners for connecting with fixtures and connective plates are provided on both ends of the center column; the center column has 6 grooves regularly arranged thereon, and a plurality of LED chips are arranged on each of the grooves to form the light source with 360-degree light irradiation.

In addition, materials having high reflectivity are provided on the grooves, the highly reflective materials being an optically reflective PC, a reflective pasted film or a vacuum UV plated film.

Further, fans for heat dispersion are provided on the lamp heads.

In addition, hollow channel in which liquid for heat dispersion is contained is provided in the center column.

Further, low power LEDs that are attached to the center column 3 or COB packaged LEDs is employed as LED chips.

In addition, the LED chips are directly fixed to a silver plated aluminium tube.

Further, the plurality of LED chips are white light LEDs or blue light LEDs.

In addition, the luminous tube is a PC diffusive cover or a luminous tube formed by mixing fluorescent powder and PC.

The LED tubular lamp according to the invention can emit light at an angle of 360 degrees, thereby increasing the range of the irradiation of the luminous tube, making light more even and the problem of glaring being solved. The LED tubular lamp according to the invention increases the luminous efficiency of the lamp as a whole, thereby not only increasing optical efficiency of the lamp as a whole but also reducing photothermal effect and improving the stability and reliability of the system.

### BRIEF DESCRIPTION OF THE FIGURES

FIG. 1 is a schematic exploded view of a LED tubular lamp according to the present invention; and

FIG. 2 is a partially enlarged view of center column of the LED tubular lamp according to the present invention.

### DETAILED DESCRIPTION OF THE INVENTION

The details of the present invention are set forth in the accompanying drawings and the embodiments below. It should be understood that the following embodiment is used for illustrative purpose rather than limitation of the scope of the invention.

### First Embodiment

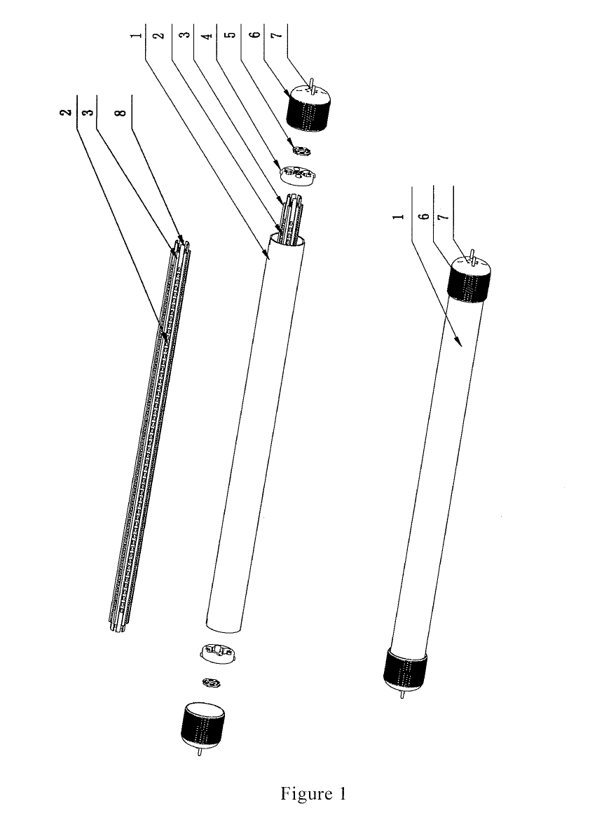

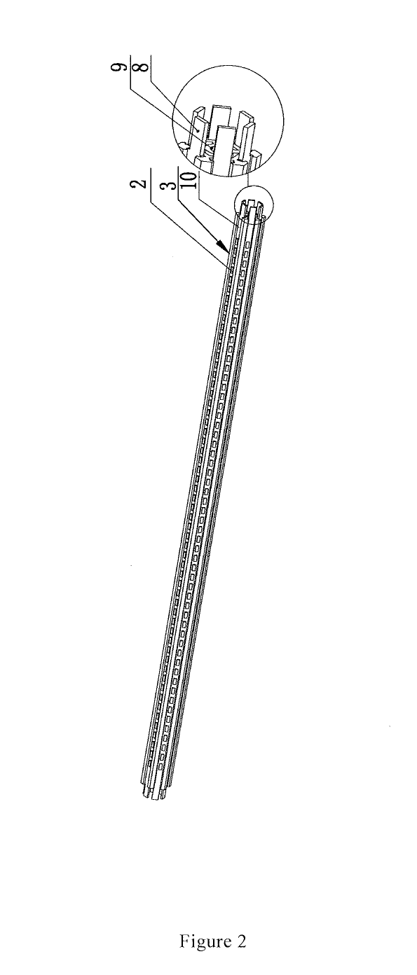

As shown in FIGS. 1 and 2, a LED tubular lamp comprises: a luminous tube 1, a center column 3, a plurality of LED chips 2, fixtures 4, connective plates 5 and lamp heads 6. A plurality of grooves 10 are provided on the center column 3. The plurality of LED chips 2 are arranged on the grooves 10. The plurality of LED chips 2 are arranged on the grooves 10 so as to form a light source with 360-degree light irradiation. The plurality of LED chips 2 may be blue light LEDs or white light LEDs. For example, the blue light LEDs excite the lampshade mixed with yellow fluorescent powder to emit uniform white light, or alternatively, white light LEDs emit uniform white light by a creamy white diffusive cover. Fasteners 8 are provided on both ends of the center column 3 and may be fixedly connected with fixtures 4, connective plates 5 and lamp heads 6. The fasteners 8 for connecting with fixtures 4 and connective plates 5 are provided on both ends of the center column 3. The center column 3 is a centrally positioned polygonal columnar tube that is formed as an aluminium tube with engaging grooves. Materials having high reflectivity may be also provided on the grooves 10. The highly reflective materials may be an optically reflective PC, a reflective pasted film or a vacuum UV plated film. The center column 3 has 6 grooves 10 regularly arranged thereon. A plurality of LED chips 2 are arranged on each of the grooves 10, such that each of grooves 10 may become a luminous panel which is regularly disposed on the periphery of the center column so as to have a diffusive effect. LED luminous panel is a multiple-surface luminous panel. As LED chips 2, low power LEDs that are attached to the grooves 10, low power LEDs that are attached to the center column or COB packaged LEDs may be employed. Also, the LED chips 2 may be directly fixed to a silver plated aluminium tube to reduce electrical resistance. The plurality of LED chips 2 are white light LEDs which emit uniform white light by mixture of light through a diffusive cover, or blue light LEDs which emit uniform white light through a lampshade with the fluorescent powder. The fluorescent powder can be coated inside or outside a transparent lampshade, or alternatively, the lampshade can be directly formed by fusing the fluorescent powder and transparent materials. The transparent materials may be PC and acrylic, for example. Highly reflective material is applied on the surface of the center column 3, such that the light which has been reflected by the lampshade can be reflected back to the lampshade so as to increase the luminous efficiency of the lamp as a whole. The lamp plate may employ materials having good heat conductivity such as aluminium substrate and ceramic plate as substrate. The drive manner of LED tubular lamp may employ two-end type drive or external drive, or LED tubular lamp may employ AC LED.

### Second Embodiment

As shown in FIGS. 1 and 2, a LED tubular lamp comprises: a luminous tube 1, a center column 3, a plurality of LED chips 2, fixtures 4, connective plates 5 and lamp heads 6. A plurality of grooves 10 are provided on the center column 3. The plurality of LED chips 2 are arranged on the grooves 10. The plurality of LED chips 2 are arranged on the grooves 10 so as to form a light source with 360-degree light irradiation. Fasteners 8 are provided on both ends of the center column 3 and may be fixedly connected with fixtures 4, connective plates 5 and lamp heads 6. Fans 7 are provided on the lamp heads 6. The fans 7 are used to transfer heat from the LED tubular lamp. The fasteners 8 for connecting with fixtures 4 and connective plates 5 are provided on both ends of the center column 3. The center column 3 is a centrally positioned polygonal columnar tube that is formed as an aluminium tube with engaging grooves. Materials having high reflectivity may be also provided on the grooves 10. The highly reflective materials may be an optically reflective PC, a reflective pasted film or a vacuum UV plated film. The center column 3 has 6 grooves 10 regularly arranged thereon. A plurality of LED chips 2 are arranged on each of the grooves 10, such that each of grooves 10 may become a luminous panel which is regularly disposed on the periphery of the center column so as to have a diffusive effect. LED luminous panel is a multiple-surface luminous panel. As LED chips 2, low power LEDs that are attached to the center column 3 or COB packaged LEDs may be employed. Also, the LED chips 2 may be directly fixed to a silver plated aluminium tube to reduce electrical resistance. The plurality of LED chips 2 are white light LEDs which emit uniform white light by mixture of light through a diffusive cover, or blue light LEDs which emit uniform white light through a lampshade with the fluorescent powder. The fluorescent powder can be coated inside or outside a transparent lampshade, or alternatively, the lampshade can be directly formed by fusing the fluorescent powder and transparent materials. The transparent materials may be PC and acrylic, for example. Highly reflective material is applied on the surface of the center column 3, such that the light which has been reflected by the lampshade can be reflected back to the lampshade. The lamp plate may employ materials having good heat conductivity such as aluminium substrate and ceramic plate as substrate. The drive manner of LED tubular lamp may employ two-end type drive or external drive, or LED tubular lamp may employ AC LED. The fans 7 installed on the lamp heads 6 have an effect of heat dispersion on the LED tubular lamp.

### Third Embodiment

As shown in FIGS. 1 and 2, a LED tubular lamp comprises: a luminous tube 1, a center column 3, a plurality of LED chips 2, fixtures 4, connective plates 5 and lamp heads 6. A plurality of grooves 10 are provided on the center column 3. The plurality of LED chips 2 are arranged on the grooves 10. The plurality of LED chips 2 are arranged on the one of grooves 10 so as to form a luminous surface. Fasteners 8 are provided on both ends of the center column 3 and may be fixedly connected with fixtures 4, connective plates 5 and lamp heads 6. The fasteners 8 for connecting with fixtures 4 and connective plates 5 are provided on both ends of the center column 3. The center column 3 is a centrally positioned polygonal columnar tube that is formed as an aluminium tube with engaging grooves. A hollow channel 9 used to contain liquid for heat dispersion is provided in the center column 3. Materials having high reflectivity may be also provided on the grooves 10. The highly reflective materials may be an optically reflective PC, a reflective pasted film or a vacuum UV plated film. The center column 3 has 6 grooves 10 regularly arranged thereon. A plurality of LED chips 2 are arranged on each of the grooves 10, such that each of grooves 10 may become a luminous panel which is regularly disposed on the periphery of the center column so as to have a diffusive effect. LED luminous panel is a multiple-surface luminous panel. As LED chips 2, low power LEDs that are attached to the center column 3 or COB packaged LEDs may be employed. Also, the LED chips 2 may be directly fixed to a silver plated aluminium tube to reduce electrical resistance. The plurality of LED chips 2 are white light LEDs which emit uniform white light by mixture of light through a diffusive cover, or blue light LEDs which emit uniform white light through a lampshade with the fluorescent powder. The fluorescent powder can be coated inside or outside a transparent lampshade, or alternatively, the lampshade can be directly formed by fusing the fluorescent powder and transparent materials. The transparent materials may be PC and acrylic, for example. Highly reflective material is applied on the surface of the center column 3, such that the light which has been reflected by the lampshade can be reflected back to the lampshade. The lamp plate may employ materials having good heat conductivity such as aluminium substrate and ceramic plate as substrate. The drive manner of LED tubular lamp may employ two-end type drive or external drive, or LED tubular lamp may employ AC LED. The hollow channel 9, which contains inner liquid to reduce temperature, is provided in the LED tubular lamp.

The LED tubular lamp according to the invention can emit light at an angle of 360 degrees, thereby increasing the range of the irradiation of the luminous tube, making light more even and the problem of glaring being solved. The LED tubular lamp according to the invention increases the luminous efficiency of the lamp as a whole, thereby not only increasing optical efficiency of the lamp as a whole but also reducing photothermal effect and improving the stability and reliability of the system.

A detailed description of the present invention described above is disclosed with reference to the preferred embodiment of the present invention. It will be apparent to ordinary person skilled in the art that various improvements and modifications can be made to the present invention without departing from the technical principle of the present invention. Those improvements and modifications should also be regarded as protection scope of the present invention.

1. A LED tubular lamp, wherein, comprises a luminous tube, a center column, a plurality of LED chips, fixtures, connective plates and lamp heads; a plurality of grooves are provided on the center column, materials having high reflectivity are provided on the grooves, the plurality of LED chips are arranged on the grooves so as to form a light source with 360-degree light irradiation, the center column is provided in the luminous tube and fixedly connected to lamp heads via the fixtures and the connective plates.

2. The LED tubular lamp according to claim 1, wherein, fasteners for connecting with fixtures and connective plates are provided on both ends of the center column; the center column has 6 grooves regularly arranged thereon, and a plurality of LED chips are arranged on each of the grooves to form the light source with 360-degree light irradiation.

3. The LED tubular lamp according to claim 1, wherein, materials having high reflectivity are provided on the grooves, the highly reflective materials being an optically reflective PC, a reflective pasted film or a vacuum UV plated film.

4. The LED tubular lamp according to claim 1, wherein, fans for heat dispersion are provided on the lamp heads.

5. The LED tubular lamp according to claim 1, wherein, hollow channel in which liquid for heat dispersion is contained is provided in the center column.

6. The LED tubular lamp according to claim 1, wherein, low power LEDs that are attached to the center column 3 or COB packaged LEDs is employed as LED chips.

7. The LED tubular lamp according to claim 1, wherein, the LED chips are directly fixed to a silver plated aluminium tube.

8. The LED tubular lamp according to claim 1, wherein, the plurality of LED chips are white light LEDs or blue light LEDs.

9. The LED tubular lamp according to claim 1, wherein, the luminous tube is a PC diffusive cover or a luminous tube formed by mixing fluorescent powder and PC.
